(19) United States
(12) Patent Application Publication
(10) Pub. No.: US 2009/0301295 A1
(43) Pub. Date: Dec. 10, 2009

(54) Piston Arrangement of a Hydraulic Piston Machine

(76) Inventor: Brian Kane, Lohr am Main (DE)

Correspondence Address: BOYLE FREDRICKSON S.C., 840 North Plankinton Avenue, MILWAUKEE, WI, 53203, US

(21) Appl. No.: 11/793,551

(22) PCT Filed: Nov. 8, 2005
(86) PCT No.: PCT/DE2005/000201

§ 371 Date: Jul. 7, 2009

(30) Foreign Application Priority Data
Dec. 17, 2004 (DE) 10 2004 060 945.4

(51) Int. Cl. F16J 9/00

(52) U.S. Cl. 92/248

(57) ABSTRACT

A piston arrangement includes a piston which is pin-ointed to a sliding block. The sliding block is molded directly onto the piston by injection molding so that no separate process step is required. The piston itself is part of the injection mold, an extremely precise fit can be guaranteed in the hinging area of the sliding block to the piston, which fit permits a reliable connection even when the piston surface is located in the connecting area outside the given tolerance, because by directly molding the sliding blocks onto the piston the tolerances are compensated.

### BACKGROUND OF THE INVENTION

1. Field of the Invention

The invention relates to a piston arrangement of a hydraulic piston machine, for instance an axial or radial piston machine in accordance with the claims.

2. Discussion of the Related Art

In DE 102 35 813 B4 an axial piston machine is shown in which a plurality of pistons are movably arranged in a cylinder drum. Said pistons are supported on an inclined disk by their end portion distant from a piston chamber via respective sliding blocks so that upon rotation of the cylinder drum the pistons perform a stroke in the cylinder drum to suck and compress hydraulic fluid. The supply and discharge of the hydraulic fluid is controlled by a control disk arranged at the end face of the drum. In the known solution the sliding surfaces of the sliding blocks adjacent to the inclined disk are provided with a coating which is locally melted on and by which the wear of the sliding blocks is minimized. It is a drawback of this solution, however, that a considerable expenditure on manufacture is required for said coating. A method of this type is only suited for sliding blocks made of metal or non-ferrous metal.

In U.S. Pat. No. 6,183,212 B1 a radial piston pump employed as gasoline pump is disclosed in which the sliding blocks are made of plastic material and are clipped onto spherical heads of the pistons. The plastic materials used are chosen regarding their wear resistance and must have an appropriate elasticity so as to be able to clip on the sliding block. In an embodiment the clipping is simplified by way of elastic tongues formed in the clip-on area. Due to the required elasticity of the sliding block portion mounted on the piston, it may occur under unfavorable operating conditions that the sliding blocks detach from the pistons so that the pump is subjected to early wear. It is another drawback that a comparatively great mounting effort is needed for clipping the sliding blocks onto the pistons.

In U.S. Pat. No. 3,183,848 an axial piston pump is illustrated in which the sliding blocks are fastened on the piston mount by means of metal clips. Although a comparatively reliable connection between the piston and the sliding block can be ensured by said metal clips, it is a drawback, however, that the assembly is more complicated because of the metal clip additionally to be mounted than in the above-described embodiment.

### SUMMARY OF THE INVENTION

Compared to the above, the object underlying the invention is to provide a piston arrangement for a hydraulic piston machine in which the manufacturing effort is reduced.

This object is achieved by a piston arrangement for a hydraulic piston machine comprising the features of the claims.

The piston arrangement according to the invention comprises a piston which is pin-jointed to a sliding block. Said sliding block is molded directly onto the piston by injection molding so that no separate process step is required. As in this case the piston itself is part of the injection mold, an extremely precise fit can be guaranteed in the hinging area of the sliding block to the piston, which fit permits a reliable connection even when the piston surface is located in the connecting area outside the given tolerance, because by directly molding the sliding blocks onto the piston said tolerances are compensated.

The piston mount supporting the sliding block is preferably spherical and positively encompassed by the sliding block so that a ball joint which cannot be released non-destructively is formed.

In an especially preferred embodiment a conduit including a nozzle which ends in the sliding surface passes through the piston and the sliding block. In this conduit the hydraulic fluid is guided from the piston chamber to the sliding area so that the contact pressure of the sliding block at the inclined disk is reduced and, accordingly, wear is minimized.

In the solution according to the invention the afore-mentioned nozzle can be formed either in the piston or in the sliding block.

Since the piston and the sliding block are swiveled relative to each other during rotation of a cylinder drum of the piston machine, the portion of the conduit located in the sliding block and the portion of the conduit located in the piston must be designed such that during said relative swivel the hydraulic fluid connection remains open toward the sliding surface. In a preferred embodiment this is permitted by the fact that in the transition area between the piston and the sliding block a funnel-shaped extension is formed the opening of which is adapted to the maximum swivel angle during the relative swivel of these component parts.

In order to further support the sliding blocks an annular end face which is approximately in the same plane as the opening facing the piston of the conduit portion passing through the sliding block may be formed at the outer circumference thereof. Said annular end face can be constituted, for instance, by an annular groove.

In accordance with the invention, it is preferred when the sliding block is made of PEEK. This material excels by good extruding capability, little shrinkage during the solidifying operation and high wear resistance, and therefore it is particularly suited for the sliding block design according to the invention.

The piston may also be manufactured of plastic material so that, for instance, the piston and the sliding block can be successively injected in one mold.

Further advantageous developments of the invention are the subject matter of further subclaims.

### BRIEF DESCRIPTION OF THE DRAWINGS

Hereinafter preferred embodiments of the invention will be illustrated in detail by way of schematic drawings, in which:

FIG. 1 is a three-dimensional view of a piston arrangement as it can be employed in an axial piston machine;

FIG. 2 is a longitudinal section across the piston arrangement according to FIG. 1;

FIG. 3 is a partially broken away cross-sectional view of the alternate embodiment of FIG. 4, illustrating the piston and sliding block during relative swivel; and

FIG. 4 is cross-section view of an alternate embodiment of a piston arrangement, similar to FIG. 2.

### DETAILED DESCRIPTION OF THE PREFERRED EMBODIMENTS

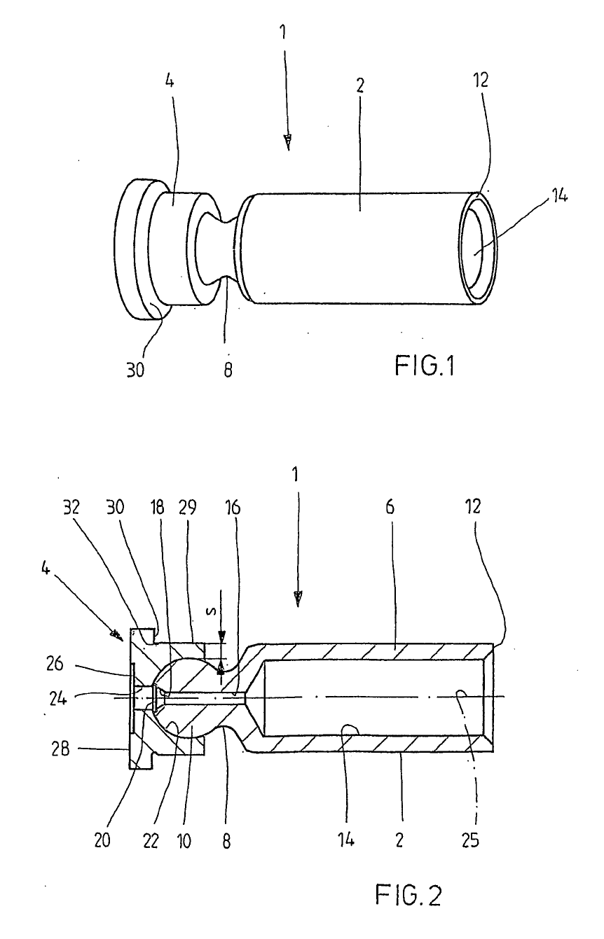

FIG. 1 shows a three-dimensional view of a piston arrangement 1 as it can be employed in an axial piston machine. Regarding the basic structure of axial piston machines of this type it is referred to the specialized literature, e.g. DE 102 35 813 B4 cited in the beginning. The piston arrangement 1 consists of a piston 2 provided with a sliding block 4. In the shown embodiment the piston consists of CrMo steel, the sliding block 4 is made of wear-resistant thermoplastic material, for example reinforced PEEK. As will be illustrated in detail in the following, the special feature is that this sliding block 4 is molded directly onto the piston 2 and thus is reliably connected to the same.

FIG. 2 shows a longitudinal section across the piston arrangement 1 according to FIG. 1. Accordingly, the piston 2 has a cylindrical portion 6 which is transformed into a spherical piston mount 10 via a constriction 8. An axial bore which is extended into a chamber 14 toward an annular end face 12 of the piston 6 passes through the piston 2. In the area of the piston mount 10 the axial bore is narrowed to form a nozzle 16 which axially ends via a funnel-shaped extension 18 in a flattened end face area 20 of the piston mount 10. The geometry of the flattened portion 20 is chosen such that the circumferential edge thereof encompasses the opening of the extension 18.

In the chamber 14 a suction valve body of the axial piston machine can be guided.

The spherical piston mount 10 immerses into a universal ball joint-type connecting portion 22 of the sliding block 4, wherein said connecting portion 22 covers the outer circumference of the piston mount 10 beyond its maximum diameter such that the sliding block 4 and the piston mount 10 are reliably interconnected by a counterdraft. The wall thickness S of the connecting portion 22 is selected so that the sliding block 4 cannot be removed from the piston 6 by elastic deformation during operation of the piston machine, and consequently this connection can be disconnected by force only—such a load does not occur in normal operation of the pump, however.

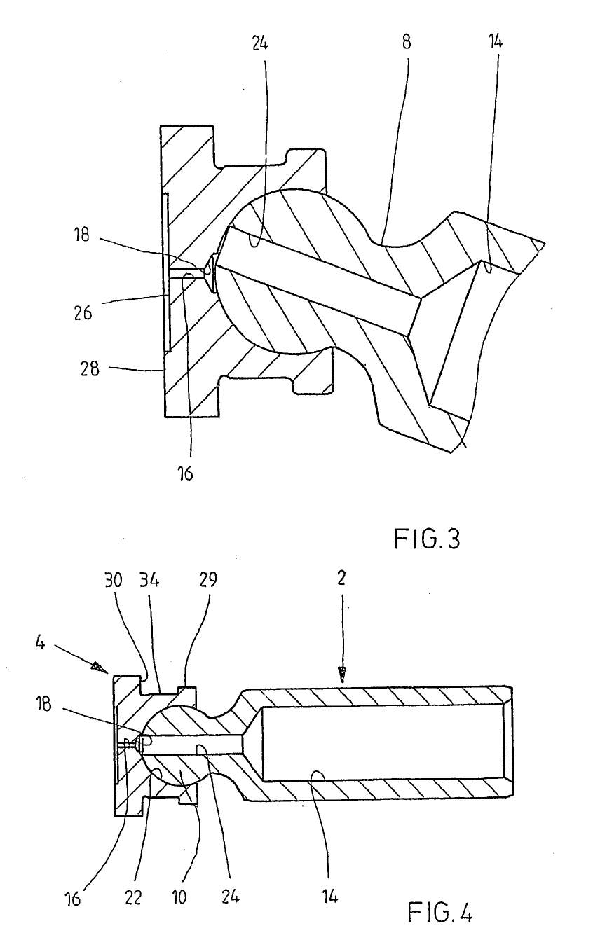

In the sliding block 4 a conduit portion 24 ending via a pocket 26 in a sliding surface 28 of the sliding block 4 by which the latter is seated on an inclined disk of the axial piston machine is connected to the funnel-shaped extension 80. The diameter of the conduit portion 24 is selected to be larger than the diameter of the nozzle 16 and is designed such that even with a relative swivel between the piston 2 and the sliding block 4 (cf. FIG. 3) the hydraulic fluid flow path through the piston arrangement remains open. That is to say, in the embodiment shown in FIG. 2 even in the case of a relative swivel there is a partial covering between the conduit portion 24 and the funnel-shaped extension 18. The annular end face 12 forming a valve seat for the suction valve including the adjacent end face areas of the chamber 14 delimits a working chamber in a cylinder drum of the axial piston machine in which a plurality of the above-described piston arrangements are guided to be axially movable. Through the afore-described hydraulic fluid flow path (chamber 14, nozzle 16, extension 18, conduit portion 24 and pocket 26) hydraulic fluid can flow from said working chamber to the sliding surface 28 so that a kind of counter-pressure reducing the contact force on the inclined disk acts upon the sliding block, wherein in the contacting area a film is formed which additionally reduces the friction of the sliding block 4 so that the wear of the latter is minimum.

As explained in the beginning, the sliding block 4 is molded directly onto the piston mount 6. For this purpose, the piston 6 or, in the case of a multi-mold, a plurality of pistons 6 are inserted in the injection mold and, where appropriate, the spherical piston mount 10 is covered with a release agent. The separating plane is chosen such that it extends normal to the drawing plane in FIG. 2 across the central axis 25. The direct molding is preferably performed in the area facing the piston 6, FIG. 2 shows a preferred position of said molding point denoted with the reference numeral 29. Then the melt flows around the spherical piston mount 10 and fills the mold cavity so that the counterdraft shown in FIG. 2 is formed. In order to avoid clogging of the nozzle 16, in this area, a molder's pin is inserted by which then also the contour of the conduit portion 24 and of the pocket 26, where appropriate, is formed.

In the embodiment shown in FIG. 2 the outer circumference of the sliding block 4 is reset in the right-hand area (view according to FIG. 2) so that an annular end face 30 is formed which, in order to avoid excessive notching forces, is transformed via a flute 32 into the connected cylindrical circumferential surface. On said annular end face 30 and on the connected reset cylindrical surface a holding means may be supported by which the sliding blocks 4 of the axial piston pump are fixed with reference to a drive shaft in axial direction and in the direction of rotation and are biased in the direction of the inclined disk.

In the FIGS. 3 and 4 an alternative embodiment of a piston arrangement 1 is shown, wherein FIG. 4 shows a longitudinal section corresponding to FIG. 2 and FIG. 3 shows the piston 6 and the sliding block 4 of said piston arrangement during relative swivel.

The basic structure of the embodiment shown in FIGS. 3 and 4 most largely corresponds to the afore-described embodiment so that here only the differences are explained and, moreover, for corresponding components the same reference numerals are used. As in the above-described embodiment, the sliding block 4 is molded directly onto the piston 2 by injection molding so that the piston mount 10 of the piston 2 is encompassed by the universal ball joint-type connecting area 22. In contrast to the afore-described embodiment, in the variant shown in FIGS. 3 and 4 the nozzle is not formed in the piston 2 but in the sliding block 4. Accordingly, the nozzle 16 ends via the funnel-shaped extension 18 likewise formed at the sliding block 4 in the part of the connecting area 22 positively encompassing the piston mount 10. In the piston mount 10 a conduit portion 24 is formed which, on the one hand, ends in the crown of the piston mount 10 and, on the other hand, in the chamber 14. The diameter of the conduit portion 24 in turn is larger than that of the nozzle 16 which ends in a pocket 26 of the sliding surface 28. It is evident from FIG. 3 that with a relative swivel between the piston 2 and the sliding block 4 the covering between the conduit portion 24 and the opening area of the funnel-shaped extension 18 is retained so that the hydraulic fluid flow path from the working chamber delimited by the end face of the piston 2 to the sliding surface 28 remains open.

The manufacture is similar to the afore-described embodiment, wherein the funnel-shaped extension 18 and the nozzle 16 are formed in the sliding block 4 by the molder's pin sealing the piston 2 at the end face. The molding point 29 again is located in the same area as in the above-described embodiment. In the shown embodiment the annular end face 30 is formed by an annular groove 34 which is introduced in the radially reset cylindrical portion of the sliding block 4; the afore-described connecting means of the axial piston machine is adapted to engage in the annular groove 34 formed. In this embodiment the opening area of the funnel-shaped extension 18 on the side of the spherical mount is located in the same plane in which the annular end face 80 is located. This feature is also fulfilled in the embodiment shown in FIGS. 1 and 2.

By the direct molding of the sliding block 4 onto the piston 2 and the above-described stable design of the connecting area 22 having a comparatively large wall thickness a reliable connection between the piston 2 and the sliding block 4 is brought about. Moreover, no additional operating step has to be provided for mounting the sliding block 4 onto the piston 2 so that also the effort in terms of manufacture is considerably reduced vis-à-vis the conventional solutions. If the process is run appropriately, also the use of a releasing agent can be dispensed with, the injection molding operation then has to be adjusted such that the desired sliding fit adjusts between the piston mount 10 and the sliding block 4. As a matter of fact, instead of the above-described material pairings (carbon fiber-reinforced PEEK, CrMo steel) also a different suitable combination of materials can be employed which permits a direct molding or forming of the sliding block 4 onto the piston 2. In this way, also the piston 2 can be manufactured of plastic material in the injection molding method, wherein by shifting the mold can permit a manufacture of both the sliding block and the piston. In so doing, first the piston and then the sliding block can be manufactured by direct molding. According to the invention, also the inverse order is possible, however.

There is disclosed a piston arrangement of a hydraulic piston machine, for example, an axial piston machine. A sliding block is placed on the piston. According to the invention, said sliding block is molded directly onto the piston, for example by injection molding.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

We claim:

1. A piston arrangement of a hydraulic piston machine, comprising a piston supporting a sliding block of plastic material the sliding surface of which is adapted to be brought into contact with a support surface of the piston machine, wherein the piston and the sliding block are pin-jointed to each other, wherein the sliding block is molded onto the piston directly or preferably by injection molding.

2. A piston arrangement according to claim 1, wherein a piston mount of the piston connected to the sliding block is spherical and is positively encompassed by the sliding block.

3. A piston arrangement according to claim 1 wherein a conduit which ends in the sliding surface passes through the piston and the sliding block.

4. A piston arrangement according to claim 1, wherein the nozzle and a conduit portion formed in the sliding block are formed by a molder's pin of an injection mold.

5. A piston arrangement according to claim 1, wherein the nozzle is formed in the piston.

6. A piston arrangement according to claim 5, wherein a funnel-shaped extension is formed in the transition area between the sliding block and the piston.

7. A piston arrangement according to claim 6, wherein the funnel-shaped extension is formed at the piston and ends in a flattened portion of the piston mount.

8. A piston arrangement according to claim 1, wherein at the outer circumference of the sliding block an annular end face is formed which is located approximately in the plane in which the piston-side opening of the sliding block is disposed.

9. A piston arrangement according to claim 8, wherein the annular end face is formed by an annular groove.

10. A piston arrangement according to claim 1, wherein the sliding block is made of reinforced PEEK.
